(19) United States
(12) Patent Application Publication
(10) Pub. No.: US 2005/0199646 A1
(43) Pub. Date: Sep. 15, 2005

(54) Method and system for providing a beverage having a customized color

(76) Inventor: Christopher J. Moy, Newport, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/075,588

(22) Filed: Mar. 9, 2005

Related U.S. Application Data
(60) Provisional application No. 60/551,663, filed on Mar. 9, 2004.

(51) Int. Cl. B67B 7/00; G01F 11/00; B67D 5/56

(52) U.S. Cl. 222/1; 222/129.4

(57) ABSTRACT

A method and system for ordering and providing a customized beverage is provided. In accordance with the present invention a graphic interface is provided to solicit objective and quantitative input from a consumer that is in turn utilized to produce a customized beverage that corresponds to the desired specifications of the consumer. The preferred embodiment of the invention utilizes an interface that includes an array of colored selections thereon, where each of the selections correspond to the resultant color of the customized beverage.

### CROSS-REFERENCE TO RELATED APPLICATIONS

This application is related to and claims priority from earlier filed U.S. Provisional Patent Application No. 60/551,663, filed Mar. 9, 2004.

### BACKGROUND OF THE INVENTION

The present invention relates generally to a method and system for customizing the color of a beverage based on the particular tastes of the ultimate consumer of the beverage. More specifically, the present invention is directed to a method and system whereby preferences regarding the amount of cream to be added to the beverage are collected from the consumer by utilizing a selection interface. The selection interface is particularly novel in that the interface includes a color keyed selection matrix from which a consumer selects the resultant color of their beverage by referring to the matrix, wherein the consumer selection ultimately translates into the amount of cream that will be added to the beverage.

There is a high demand for prepared beverages that are customized to the particular and individualized tastes of the end consumer. Such beverages include but are not limited to coffee based beverages, teas and cocas. In order to customize these beverages to suit the individual tastes of each consumer, a number of variables exist that each must be addressed during the preparation of the beverage in order to produce a beverage that is acceptable to the consumer. This is particularly true in the case of prepared coffee beverages, which can be prepared many ways. One popular method involves first grinding the coffee beans. Then, the ground coffee is placed in a filter, and hot water is poured over the grounds to brew them. The brewed coffee is dispensed into a cup or other container and served hot. Many coffee drinkers like to customize their beverage by varying the amount of sweetener and dairy product added to the beverage, so that it has a particular taste and color shade. For instance, some coffee drinkers prefer “dark” coffee without any milk, cream, or other lightening agent added to the coffee. Other coffee drinkers prefer “light” coffee with a relatively large amount of milk or cream added. Also, some coffee drinkers add varying amounts of sugar or other sweetening agents to the coffee, the addition of which results in changing the overall taste of the prepared beverage. Similarly, as can be appreciated in the art, these factors are equally applicable when preparing any of the other beverages disclosed above.

The difficulty encountered is that in the typical commercial setting, where such customized beverages are produced in a high volume, a consistent system that produces predictable customization of such beverages on an individual basis is not available. Today, consumers order coffee at a variety of places including dine-in restaurants, convenience stores, coffee/donut shops, cafés or fast-food restaurants. When producing customized beverages in this manner, there are numerous issues that must be overcome to deliver, on demand, an individually customized beverage to a wide range of consumers. Some of these businesses make large volumes of coffee beverages daily, and it often is difficult to customize each and every beverage to the individual consumer's tastes. Of course, one option is to allow the consumer themselves to add condiments directly to the beverage at many retail locations. In this manner, the consumer can customize the color and taste of the coffee to any desired flavor. However, at some coffee “drive-thrus” and other quick stops, this method is not easily implemented and the consumer must order the beverage with condiments included where another person is responsible for preparing the beverage in accordance with the consumer's tastes. In this case, each consumer must select from several variables in order to instruct the preparer of the beverage regarding his/her particular tastes. When ordering a beverage such as coffee using this method, the consumers try to communicate their order by using such random terms as “light,” “medium,” “tan,” “brown,” “dark,” “a little milk,” and the like to describe the requested coffee. The difficulty encountered is that none of these terms are actually quantifiable and each term is subject to the judgment of the preparer as to its relative meaning. The person, who is preparing the coffee, then interprets these subjective terms and tries to make the requested coffee color and flavor by adding and blending assorted ingredients to the brewed coffee. As can be appreciated, it is quite difficult to prepare the optimum coffee beverage using this traditional system. The prepared coffee is too often either a random “hit” or “miss” with the consumer.

To further complicate the problem identified above, a wide range of lightening agents are used in these beverages. Lightening agents may include whole milk, skim milk, low fat milk, cream, non-dairy creamer, soy milk, etc. An equal amount of each one of these lightening agents would produce an entirely different lightening effect when added to a beverage. When producing a beverage using whole milk, a certain quantity of whole milk would be necessary to arrive at the desired color. When producing the same beverage using skim milk, a much larger quantity of skim milk would be necessary to arrive at the same resultant color.

In view of the foregoing, there is a need for a method and system of providing a customized beverage that includes a quantifiable and non-subjective interface by which the customer selects various qualities of their coffee. Further, there is a need for a method and system of providing a customized beverage that will provide consistent and predictable results on-demand. There is also a need for a system that provides a consistent colored beverage regardless of the lightening agent that is utilized. Further, the system and method must be capable of being implemented for use at restaurants, drive-thru stops, and other coffee retail locations.

### BRIEF SUMMARY OF THE INVENTION

In this regard, the present invention provides a method and system for providing a customized beverage based on objective and quantifiable input that is solicited from the consumer. In particular, the present invention is primarily directed at soliciting quantifiable input from a consumer regarding the desired color of their customized beverage that is then in turn used to produce the customized beverage for the consumer.

In accordance with the present invention, an interface is provided that includes a matrix having a range of selections arranged therein. Each of the selections is placed into a position within the matrix and varies from relatively light to relatively dark. The selections within the matrix may be numeric or simply a series of colored cells that have a color corresponding to the ultimate color of the customized beverage. In the preferred embodiment, the selections include both a color and a number for selection purposes. Using the interface of the present invention, a consumer first selects a color shade that most closely matches the color that they desire for their customized beverage. The consumer communicates this color selection to the preparer of the beverage. The preparer of the beverage then utilizes the consumer's color selection to then add a specified amount of lightening agent as will be fully described below to produce a customized beverage having the exact color that was identified by the consumer of the beverage.

The present invention provides an interface that can be implemented using traditional menu boards such as are typically seen at drive-thru ordering stations, printed menus or even computerized ordering terminals. Ultimately the novelty of the present invention resides in the general concept of providing a color keyed selection process by which objective and quantifiable input regarding the desired color of the customized beverage is obtained from the consumer thereby standardizing the criteria by which the ultimate color of the customized beverage is prepared.

Accordingly, it is a general object of the present invention to provide an improved process for providing an individually customized beverage on demand by a consumer, in a wide range of variety and strength. It is a further object of the present invention to provide a system and process by which a consumer can order a customized beverage while being assured of consistent results. It is yet a further object of the present invention to provide a method and system by which objective and quantifiable input is solicited from the consumer regarding the desired color of their customized beverage which can in turn be utilized to produce a beverage that will be satisfactory to the consumer. It is yet a further object of the present invention to provide a graphic interface to which a consumer can refer in order to provide quantifiable input to the preparer of a customized beverage regarding the amount of lightening agent that must be added to the beverage to meet the consumer's tastes. It is still a further object of the present invention to provide an ordering interface for selection of the desired color of a customized beverage that is particularly useful for providing a beverage according to individual consumer selection, but in large, commercial or institutional quantities.

These together with other objects of the invention, along with various features of novelty, which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a flow chart showing the system for providing a customized beverage of the present invention;

FIG. 2 is a perspective view of one possible interface for the customized beverage system of the present invention;

FIG. 3 is a plan view of an alternate interface for the customized beverage system of the present invention; and

FIG. 4 is a schematic illustration of a dispensing system for use with the customized beverage system of the present invention.

### DETAILED DESCRIPTION OF THE INVENTION

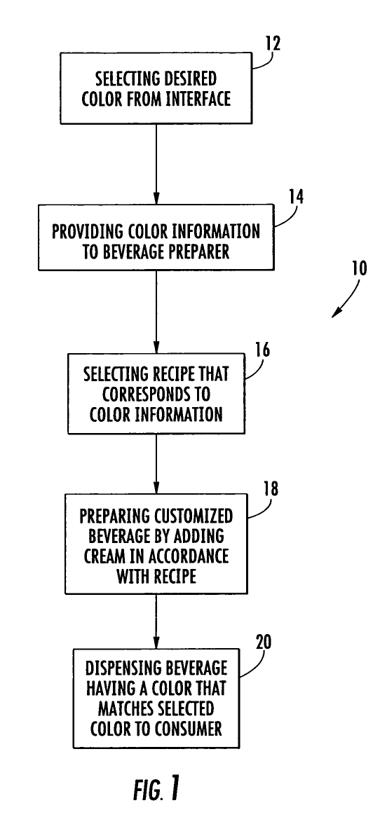

Now referring to the drawings, the method of providing a customized beverage of the present invention is shown and illustrated in the flow chart in FIG. 1. The method 10 of the present invention is directed to several steps that are tailored to obtain objective and quantifiable input from a consumer regarding their personal preference regarding the resulting color of their customized beverage so that the input can be utilized to produce a customized beverage in accordance with the consumer's preference. As can be seen in FIG. 1, in the first step, the consumer selects the desired beverage color 12 from an interface as will be fully described below. In the next step, the color selected by the consumer 12 is then conveyed to the beverage preparer 14. The preparer, using the selected color, refers to a recipe 16 that instructs the preparer as to the manner in which the beverage should be prepared to obtain a customized beverage having the desired color. Once the recipe is known 16, the preparer then prepares the beverage in accordance with the recipe 18. Finally, a completed beverage is dispensed to the consumer 20, wherein the beverage has a color that corresponds to the color selected by the consumer is the first step 12. As can be seen therefore, the method 10 of the present invention provides a novel method of providing a customized beverage that allows both the consumer and the beverage preparer to communicate in an objective and quantifiable manner regarding the qualities of the finished beverage.

The method 10 as described herein is directed to the preparation of a customized beverage. In the preferred embodiment the beverage is a coffee beverage although the teachings of the present invention may be applicable to the preparation of any beverage wherein the resulting customized beverage has a quality that may be customized by reference to its color. By way of example, the teaching of the present invention may apply not only to hot or iced coffee beverages but also to latte, cappuccino, mocha, teas and cocoa beverages.

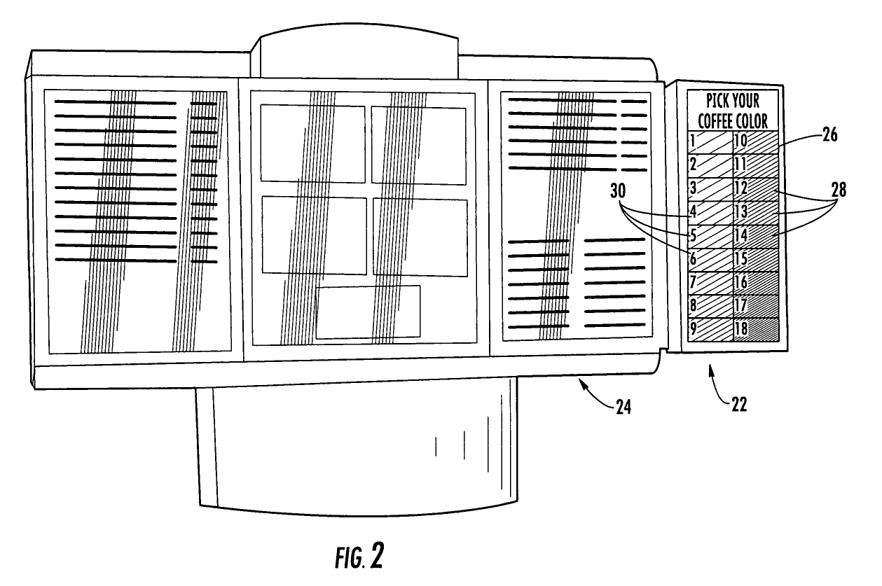

Turning now to FIG. 2, one possible embodiment for the interface 22 described in the first step 12 of the method 10 of the present invention is shown. The interface 22 is shown as a component of or attachment to typical drive-thru style menu board 24 and includes a color chart 26 disposed thereon for color selection. The color chart 26 is arranged as a matrix having numerous positions 28 therein. Each of the positions 28 in the color chart 26 has a color corresponding to a possible customized beverage color and range from a very light tan color to a very dark brown color. Further, the color chart 26 may contain as few or as many color selections as desired depending upon the business and customer demand. The color chart 26 indicated in FIG. 2 depicts 18 possible color selections that range from a very light tan color on the upper left to a very dark brown color on the lower right. Similarly, the color chart 26 may include a range of three colors or a thousand colors depending on the practicality of the given application. The color chart 26 is arranged to include a color palette representing a range of the different colors for the customized beverage that can be ordered. To facilitate use of the color chart 26 and enhance the ability of the consumer to communicate their color selection 28 to the beverage preparer, each color selection 28 on the color chart 26 may include a matching number 30. This matching number 30 system allows a consumer to select a coffee color by simply selecting a number 30. For example, a person may select “Number 4” which corresponds to a “light tan-colored” coffee. While the color chart 26 in FIG. 2 is displayed as an attachment 22 on a drive-thru menu board 24, clearly the color chart 26 could also be displayed as a countertop sign, a computer screen monitor, a point of sale device, a vending machine or other suitable advertising medium and still fall within the scope of the present invention.

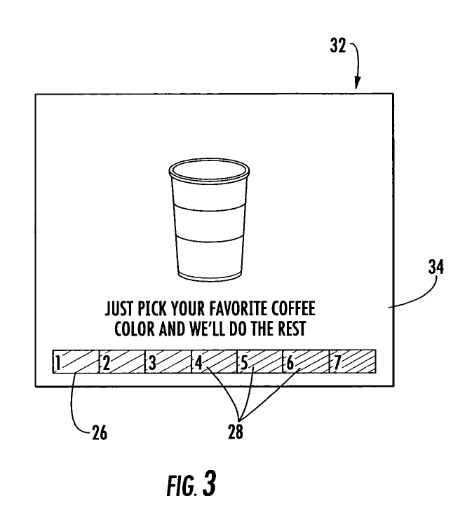

Turning to FIG. 3, an alternate interface 32 is shown. The alternate interface 32 is in the form of a flat display card 34 that includes a color chart 26 thereon. The color chart 26 includes as described above, a matrix including a range of color selections 28 from which the consumer selects the desired color for their customized beverage. In this case, the interface 32 may be a card that a consumer keeps on their person for reference or a sheet that is applied to the counter where a consumer places an order for a customized beverage. It should be appreciated that the examples provided herein are provide only for illustrative purposes and are not intended to limit the possible displays that are utilized to inform the consumer regarding the color selection chart 26.

As was stated above, once the consumer makes the color selection 28 by reference to the color chart 26, the color selection 28 information is communicated to the beverage preparer. The beverage preparer in turn utilizes the color selection 28 to determine the necessary amount of lightening agent that must be placed into the particular beverage in order to produce the resultant color. The amount of lightening agent that must be used is highly dependent on several factors, inducing the size of the beverage ordered, the type of lightening agent that is used and the type of beverage being prepared. Preferably, the beverage preparer will have available a recipe which they can reference to determine the correct ratio of beverage and lightening agent that must be utilized to produce a customized beverage having the selected color. The recipe accounts for the various factors, such as the size of the beverage and type of lightening agent, by providing the beverage preparer with the correct amount of lightening agent to add in each case. For example, a different amount of lightening agent will be utilized in each of a 16 oz, 20 oz, 24 oz, or 32 oz beverage to produce a finished beverage wherein each beverage has a color that corresponds to the color selection 28. Similarly, if the lightening agent selected were cream versus skim, milk, different amounts of cream and skim milk would be needed to produce a beverage that corresponds to the color selection 28. The recipe of ingredients that will produce the selected color 28 is pre-determined and provided for easy reference by the beverage preparer. Restaurants, coffee/donut shops, and other coffee retail shops are familiar with such recipes. The coffee recipe and corresponding color 28 can be stored in written format such as in a spread sheet or other manual log. Alternatively, a computer database or other automated program can be used for storing the coffee recipe needed to make each color selection 28 appearing in the color chart 26. In this case, the beverage preparer simply accesses the desired recipe by entering the variables such as beverage type, beverage size and lightening agent type to access the correct recipe to produce the resultant beverage matching the color selection 28.

In the context of the present application lightening agent refers to various type creamer products that are typically added to a beverage. These products include but are not limited to cream, whole milk, skim milk, reduced fat milk, non-dairy creamer, flavored creams and soy milk.

Once the beverage preparer has the color selection 28 information, the recipe corresponding to that particular color selection 28 is accessed. Then, the beverage is prepared per the directions in the recipe. The lightening agent and beverage are added in the correct ratio as directed by the recipe. Additionally, other ingredients such as sweetener can be added to the beverage and the beverage is then blended. The customized beverage is then dispensed and provided to the consumer having a completed color that corresponds to the color selection 28 provided by the consumer from the color chart 26.

It should be appreciated that the blending and dispensing step may be one in the same. For example, the ingredients may be blended in one container and then dispensed into another suitable container, such as a Styrofoam or paper cup that is then provided to the consumer. Similarly, the ingredients may be added directly to the container that is to be provided to the consumer and blended therein. Further, the blending process can be completed manually or by machine wherein the variables regarding the customized beverage are input to the machine and the machine references the correct recipe to produce the resultant customized beverage corresponding to the color selection 28.

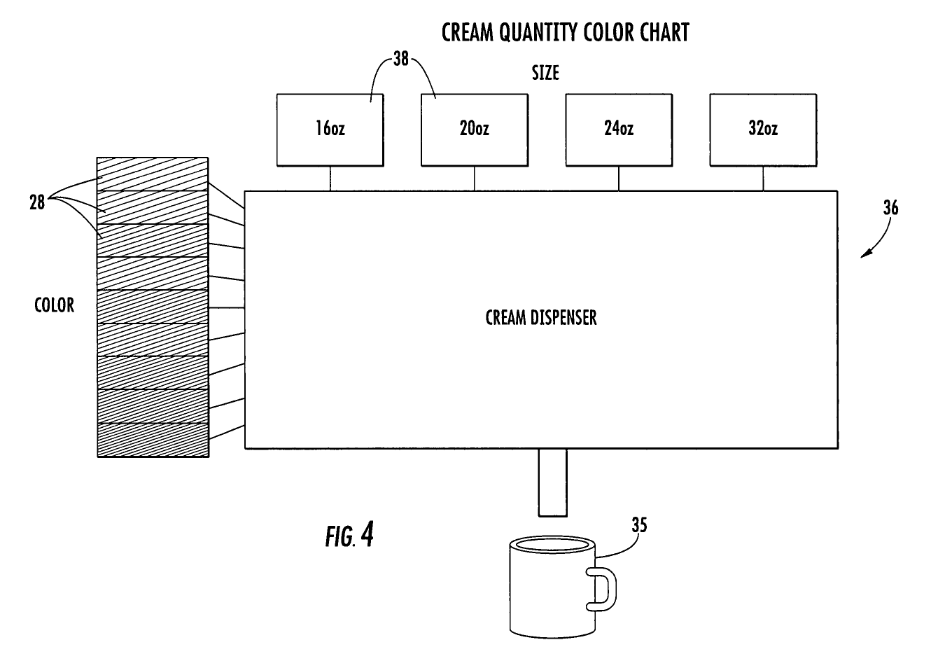

FIG. 4 shows an apparatus for automated production of a customized beverage 35. In particular, FIG. 4 is a schematic illustration of an automated cream dispenser 36 for adding cream to the customized beverage. In this case, the interface of the cream dispenser 36 includes selectors 38 for choosing the size of the beverage and color selectors 28 that allow the beverage preparer to input the necessary variables including the color selection 28 and the beverage size 38. The cream dispenser 36 then utilizes the input variables to access the necessary recipe and dispense the correct amount of cream to provide a beverage 35 having the correct color.

It can therefore be seen that the present invention provides a method and system for obtaining quantitative and objective information regarding a customer's preferences for a customized beverages in order to produce that customized beverage to the customer's satisfaction. The present invention is easily scalable, convenient and simple to use and has broad applicability. Further, the present invention can be adapted for use in a variety of point of sale interfaces to speed the accuracy and customer satisfaction associated with the production of customized beverages. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

1. A method of dispensing a customized beverage comprising the steps of:
providing a selector chart having an array of color selections thereon, each of said color selections corresponding to a color of the beverage to be dispensed;
obtaining a preferred color selection, said preferred color selection corresponding to one of said array of color selections;
mixing said customized beverage using a predetermined formula based on said preferred color selection; and
dispensing said customized beverage to a consumer, wherein the color of said customized beverage substantially matches said preferred color selection.

2. The method of claim 1, wherein said customized beverage is selected from the group consisting of: coffee based beverages, tea based beverages and cocoa based beverages.

3. The method of claim 1, said step of mixing said customized beverage further comprising:
obtaining a recipe corresponding to said preferred color selection, said recipe including a prescribed amount of lightening agent to be added to said customized beverage; and
mixing said prescribed amount of lightening agent with said customized beverage.

4. The method of claim 3, said lightening agent being selected from the group consisting of: cream, whole milk, skim milk, reduced fat milk, non-dairy creamer, flavored creams and soy milk.

5. The method of claim 3, wherein said prescribed amount of lightening agent in said recipe is adjusted in accordance with the size of said customized beverage and the type of lightening agent utilized.

6. The method of claim 1, wherein said array of color selections is an array of at least three colors ranging between light tan to dark brown.

7. The method of claim 1, said selector chart comprising a menu board.

8. The method of claim 1, said selector chart comprising a counter display.

9. The method of claim 1, said selector chart comprising a computer display.

10. An interface for selecting a customized beverage comprising:
a display means; and
an array of color selections disposed on said display means, each of said color selections corresponding to a color of a beverage to be dispensed, wherein a consumer selects a preferred color selection from said array of color selections.

11. The interface of claim 10, wherein said customized beverage is selected from the group consisting of: coffee based beverages, tea based beverages and cocoa based beverages.

12. The interface of claim 10, where each of said color selections corresponds to a recipe, said recipe including a prescribed amount of lightening agent to be added to said customized beverage.

13. The interface in claim 12, said lightening agent being selected from the group consisting of: cream, whole milk, skim milk, reduced fat milk, non-dairy creamer, flavored creams and soy milk.

14. The interface in claim 12, wherein said prescribed amount of lightening agent in said recipe is adjusted in accordance with the size of said customized beverage and the type of lightening agent utilized.

15. The interface in claim 10, wherein said array of color selections is an array of at least three colors ranging between light tan to dark brown.

16. The interface in claim 10, said display means comprising a menu board.

17. The interface in claim 10, said display means comprising a counter display.

18. The interface in claim 10, said display means t comprising a computer display.

19. An apparatus for dispensing a customized beverage comprising:
an interface, said interface including an array of color selections disposed thereon, each of said color selections corresponding to a color of a beverage to be dispensed;
means for dispensing a prescribed amount of lightening agent; and
a control means, said control means in communication with said interface and said means for dispensing said lightening agent,
wherein selection of a preferred color selection on said interface causes said control means to instruct said dispensing means to dispense a prescribed amount of lightening agent into said customized beverage such that the resultant color of said customized beverage substantially matches said preferred color selection.

20. The apparatus of claim 19, said interface further including means for adjusting said prescribed amount of lightening agent in accordance with the size of said customized beverage and the type of lightening agent utilized.
